(19) United States
(12) Patent Application Publication
(10) Pub. No.: US 2023/0409028 A1
(43) Pub. Date: Dec. 21, 2023

(54) METHOD OF CONTROLLING MOVEMENT OF MOBILE ROBOT BETWEEN USER REGIONS

(71) Applicant: Electronics and Telecommunications Research Institute, Daejeon (KR)

(72) Inventors: Taehyoung SHIM, Sejong-si (KR); Jun Seob LEE, Daejeon (KR); Jeongil YIM, Daejeon (KR)

(73) Assignee: Electronics and Telecommunications Research Institute, Daejeon (KR)

(21) Appl. No.: 18/120,800

(22) Filed: Mar. 13, 2023

(30) Foreign Application Priority Data
Jun. 16, 2022 (KR) 10-2022-0073511
Dec. 13, 2022 (KR) 10-2022-0173741

(51) Int. Cl. G05D 1/00

(52) U.S. Cl. CPC G05D 1/0027; G05D 1/0016; G05D 1/0022

(57) ABSTRACT

Provided is a method performed by a user device to control a movement of a mobile robot between user regions. The method includes setting user boundaries, transmitting data about the set user boundaries to the mobile robot, transmitting a movement control request to the mobile robot in response to an input of a user service request, identifying a region where the mobile robot is located by performing positioning on the mobile robot, and allowing the movement control of the mobile robot to be stopped by transmitting a confirmation signal to the mobile robot when the identified region where the mobile robot is located is the same as the target region.

### CROSS-REFERENCE TO RELATED APPLICATIONS

This application claims the benefit of Korean Patent Application No. 10-2022-0073511 filed on Jun. 16, 2022, and Korean Patent Application No. 10-2022-0173741 filed on Dec. 13, 2022, in the Korean Intellectual Property Office, the entire disclosures of which are incorporated herein by reference for all purposes.

### BACKGROUND

### 1. Field of the Invention

One or more embodiments relate to a technical field of controlling a movement of a mobile robot.

### 2. Description of the Related Art

Autonomous mobile robots have been used to perform tasks such as field reconnaissance, handling and disposing of weapons or explosives in cold environments, for example, in combat or rescue situations, and various other procedures that risk human casualties if performed by humans. Recently, the autonomous mobile robots have been increasingly used for the purpose of providing convenience to humans in various service fields. A movement of the autonomous mobile robots used for service purposes are controlled by a user device to be close to or at a predetermined distance from a user according to a user request.

### SUMMARY

The technical goal obtainable from the present disclosure is not limited to the above-mentioned technical goal, and other unmentioned technical goals may be clearly understood from the following description by those having ordinary skill in the technical field to which the present disclosure pertains.

Embodiments provide technology for controlling a movement of a mobile robot between user regions.

According to an aspect, there is provided a method performed by a user device to control a movement of a mobile robot between user regions including setting user boundaries, wherein a plurality of regions based on the user device is defined by the user boundaries, transmitting data about the set user boundaries to the mobile robot, transmitting a movement control request to the mobile robot in response to an input of a user service request, wherein the movement control request is a request to perform a movement control to move the mobile robot to a target region, and the target region is one of the plurality of regions, identifying a region where the mobile robot is located by performing positioning on the mobile robot, and allowing the movement control of the mobile robot to be stopped by transmitting a confirmation signal to the mobile robot when the identified region where the mobile robot is located is the same as the target region.

The method may further include, prior to the transmitting of the movement control request to the mobile robot in response to the input of the user service request, previously identifying a region where the mobile robot is located by performing positioning on the mobile robot, wherein the region where the mobile robot is located is one of the plurality of regions, wherein the target region may be different from the previously identified region where the mobile robot is located.

The method may further include, prior to the transmitting of the movement control request to the mobile robot in response to the input of the user service request, determining a value of at least one positioning variable based on the previously identified region where the mobile robot is located.

The identifying of the region where the mobile robot is located by performing the positioning on the mobile robot may include applying the determined value of the at least one positioning variable and identifying the region where the mobile robot is located, by performing the positioning on the mobile robot.

The at least one positioning variable may include at least one of a wireless signal bandwidth, an information transmission period, and transmission power.

The determining of the value of the at least one positioning variable based on the previously identified region where the mobile robot is located may include determining the wireless signal bandwidth to be relatively wide, determining the information transmission period to be relatively short, and determining the transmission power to be relatively low, when the identified region in advance where the mobile robot is located is a region relatively close to the user device.

The determining of the value for at least one positioning variable based on the identified region in advance where the mobile robot is located may include determining the wireless signal bandwidth to be relatively narrow, determining the information transmission period to be relatively long, and determining the transmission power to be relatively high, when the identified region in advance where the mobile robot is located is a region relatively far from the user device.

The method may further include, after the identifying of the region in advance where the mobile robot is located by performing the positioning, transmitting data about the identified region in advance where the mobile robot is located to the mobile robot.

The method may further include, after the determining of the value for at least one positioning variable based on the identified region in advance where the mobile robot is located, transmitting data about the determined value of at least one positioning variable to the mobile robot.

According to an aspect, there is provided a method performed by a mobile robot to control a movement of a mobile robot between user regions including receiving data about user boundaries from a user device, wherein a plurality of regions based on the user device is defined by the user boundaries, identifying a location of the user device, receiving data about a region where the mobile robot is located from the user device, performing a movement control on the mobile robot, based on the data about the user boundaries, the identified location of the user device, and the data about the region where the mobile robot is located, in response to receiving a movement control request from the user device, and stopping the movement control on the mobile robot in response to receiving a confirmation signal from the user device.

The movement control request may be a request to perform the movement control to move the mobile robot to a target region, wherein the target region is one of the plurality of regions and a region different from the region where the mobile robot is located.

Additional aspects of embodiments will be set forth in part in the description which follows and, in part, will be apparent from the description, or may be learned by practice of the disclosure.

According to embodiments, there is a technical effect that may control a movement of a mobile robot between user regions.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating controlling a movement of a mobile robot between user regions by a user device according to an embodiment;

FIGS. 2A and 2B are diagrams illustrating a method of performing positioning between the user device and the mobile robot of FIG. 1 according to an embodiment; and

FIG. 3 is a flowchart illustrating a method of controlling a movement of a mobile robot between user regions according to an embodiment.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as “first”, “second”, and the like, may be used herein to describe components. Each of these terminologies is not used to define an essence, order or sequence of a corresponding component but used merely to distinguish the corresponding component from other component(s). For example, a “first” component may be referred to as a “second” component, or similarly, and the “second” component may be referred to as the “first” component within the scope of the right according to the concept of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and any repeated description related thereto will be omitted.

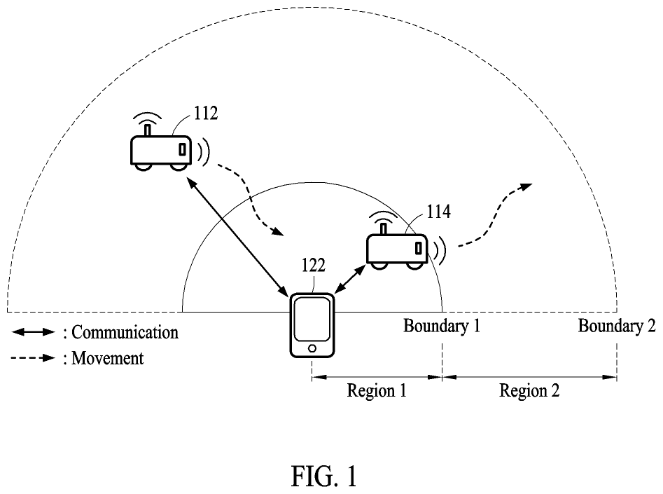

FIG. 1 is a diagram illustrating controlling a movement of a mobile robot between user regions by a user device according to an embodiment.

According to the present disclosure, as shown in FIG. 1, technology for controlling a movement of mobile robots 112 and 114 between a region 1 that is between a user device 122 and a boundary 1 and a region 2 that is between the boundary 1 and a boundary 2 is provided by the user device 122. The boundaries and the regions as illustrated may be defined by the user device 122, and information about the boundaries and/or the regions may be transmitted from the user device 122 to the mobile robots 112 and 114 and be shared between the user device 122 and the mobile robots 112 and 114. The boundary 1 illustrated may be defined as a short radial distance (e.g., 2 meters (m)) based on a location of the user device 122, and the boundary 2 illustrated may be defined as a relatively long radial distance (e.g., 10 m) based on the location of the user device 122. In another embodiment, the boundary 1 may be a rectangular boundary that narrowly encloses the user device 122 and the boundary 2 may be a rectangular boundary that encloses the user device 122 more widely than the boundary 1. The boundary 1 and the boundary 2 may be arbitrarily set as the boundary 1 is a distance that allows a user (not shown) to comfortably access a mobile robot, and the boundary 2 is a distance that prevents the mobile robot from interfering with the user. In the illustrated embodiment, the two regions (the region 1 and the region 2) may be defined by the two boundaries (the boundary 1 and the boundary 2), but the number of defined boundaries and/or regions is not limited thereto. The user device 122 may be located indoors or outdoors. The user device 122 may control the mobile robot 112 to access the region 1 through communication with the mobile robot 112 to receive services such as beverage delivery, luggage delivery, and the like from the mobile robot 112 located in the region 2. In another example, the user device 122 may control the mobile robot 114 to move to the region 2 through communication with the mobile robot 114 to physically separate the mobile robot 114 from the user device 122 after being serviced by the mobile robot 114. As described above, the present disclosure has an advantage of simplifying controlling the movement of the mobile robot by controlling the mobile robots to move only between regions that is defined by the user device 122 without controlling the mobile robots to move to a correct location based on accurate positioning information.

The user device 122 and the mobile robots 112 and 114 may implement 2nd generation (2G) wireless communication networks such as a global system for mobile communications (GSM) network and code division multiple access (CDMA), a long term evolution (LTE)/long term evolution-advanced (LTE-A) network, a 5th generation (5G) network, wireless internet networks such as a wireless fidelity (WiFi) network, mobile internet networks such as worldwide interoperability for microwave access (WiMax) and wireless broadband internet (WiBro), or radio access technologies (RATs) adopted in wireless communication networks supporting packet transmission, and may include functions/characteristics of a mobile communication terminal used in such wireless communication networks, but the functions of the user device 122 and the mobile robots 112 and 114 are not limited thereto. The user device 122 may include a desktop or a laptop personal computer (PC) supporting 5G and LTE/LTE-A, portable terminals such as a tablet PC, a notebook, and a notepad, wireless communication devices based on various types of handheld devices such as a smartphone, and wearable devices such as a smartwatch, etc., but the types of the user device 122 are not limited thereto. The user device 122 and the mobile robots 112 and 114 may be equipped with at least two antennas for positioning as described below.

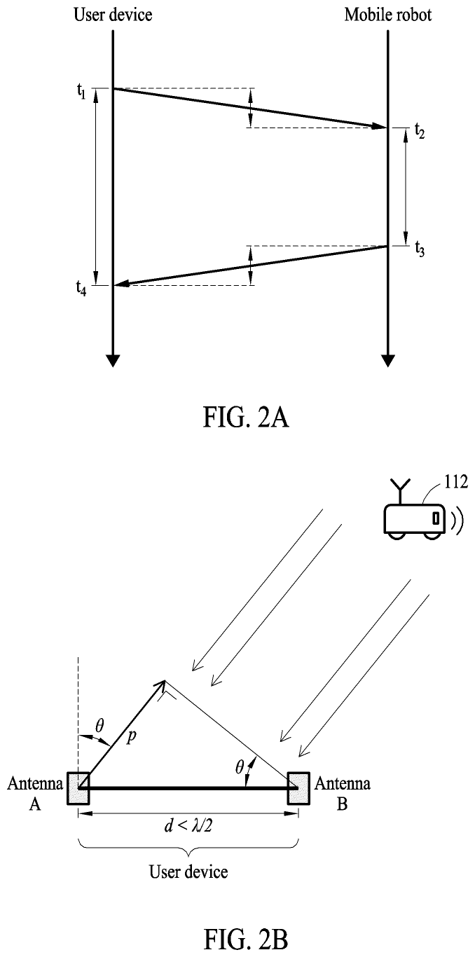

FIGS. 2A and 2B are diagrams illustrating a method of performing positioning between the user device and the mobile robot of FIG. 1 according to an embodiment.

The user device 122 and the mobile robots 112 and 114 may utilize a wireless communication-based positioning technology standard such as institute of electrical and electronics engineers (IEEE) 802.11 mc and ultra-wideband (UWB) for measuring (positioning) a distance and a direction between each other. As shown in FIG. 2A, the user device 122 may measure an accurate distance in centimeter (cm) between the user device 122 and the mobile robots 112 and 114 by measuring a round-trip time (RTT) of a wireless signal between the mobile robots 112 and 114. The user device 122 may wirelessly transmit the signal to the mobile robots 112 and 114 at time t₁. The mobile robots 112 and 114 may wirelessly receive the signal at time t₂ and wirelessly transmit the signal received at time t₃ after a predetermined delay time from the time t₂ to the user device 122 again. The user device 122 may wirelessly receive the signal transmitted from the mobile robots 112 and 114 at time t₄. Since the user device 122 has determined the time t₁ and the time t₄, the user device 122 may transmit information about the time t₁ and the time t₄ to the mobile robots 112 and 114, and since the mobile robots 112 and 114 have determined the time t₂ and the time t₃, the mobile robots 112 and 114 may transmit information about the time t₂ and the time t₃ to the user device 122. Then, the user device 122 and the mobile robots 112 and 114 may determine a distance D between the user device 122 and the mobile robots 112 and 114 according to Equation 1 below.

$$D = c \times \frac{( {t}_{4} - {t}_{1} ) - ( {t}_{3} - {t}_{2} )}{2} \qquad [ Equation 1 ]$$

Here, C may denote the speed of light.

Referring to FIG. 2B, the user device 122 may calculate a relative direction between the user device 122 and the mobile robots 112 and 114 by measuring an angle-of-arrival (AoA) of the wireless signal using at least two antennas (an antenna A and an antenna B). The mobile robots 112 and 114 may also calculate the relative direction between the user device 122 and the mobile robots 112 and 114 in the same manner. An angle θ representing the relative direction between the user device 122 and the mobile robots 112 and 114 may be determined according to Equation 2 below.

$$θ = arc sin \frac{α \cdot λ}{2 π d} \qquad [ Equation 2 ]$$

Here, λ may denote a wavelength of a communication signal exchanged between the user device 122 and the mobile robots 112 and 114, d may denote a distance between the antenna A and the antenna B, which is less than ½ of the wavelength λ of the communication signal, and a may denote a phase difference of arrival and be defined by Equation 3 below.

$$α = \frac{2 π}{λ} p = \frac{f}{c} p \qquad [ Equation 3 ]$$

Here, p may denote a path length difference, which is defined by Equation 4 below.

p=d sin(θ) [Equation 4]

In the above description, the method of performing positioning using the wireless signal between the user device 122 and the mobile robots 112 and 114 has been described, but it should be recognized that the method of performing positioning according to the present disclosure is not limited thereto. For example, the positioning may be performed using at least one sensor such as a visual camera, an inertial measurement unit (IMU), an ultrasonic sensor, and a light detection and ranging (LiDAR) sensor, and it should be understood and construed that such a positioning method is also included in the scope of the present disclosure.

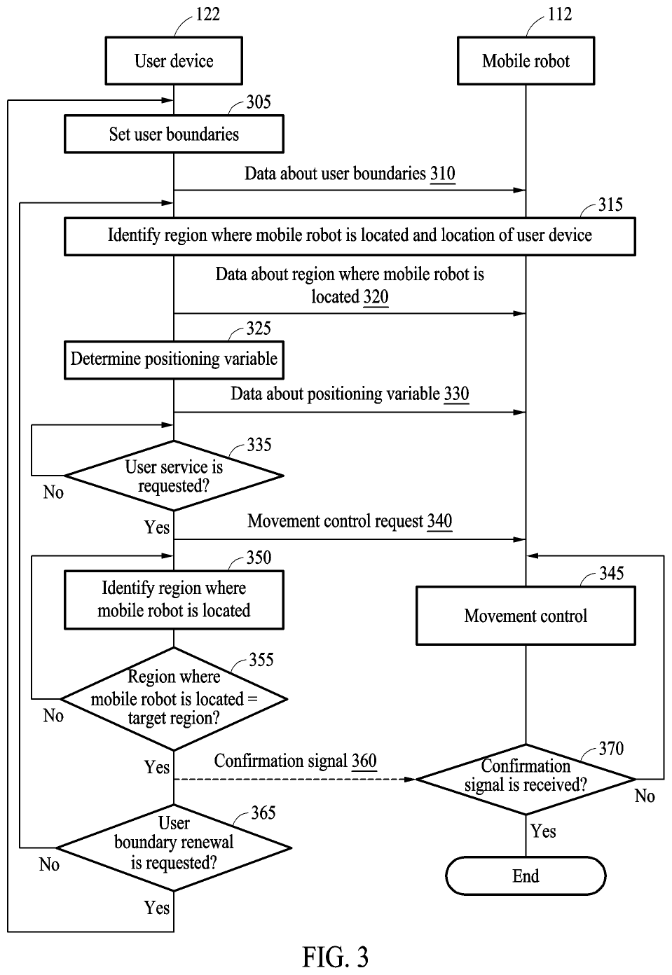

FIG. 3 is a flowchart illustrating a method of controlling the movement of the mobile robot between the user regions according to an embodiment.

The method may begin with operation 305 of setting, for example, at least two user boundaries by the user device 122 as shown in FIG. 1. In an embodiment, operation 305 may be implemented by providing a user interface screen that allows a user to set the user boundaries on the user device 122. When the user boundaries are set, at least two regions may be defined as described above. In operation 310, data about the user boundaries may be transmitted from the user device 122 to the mobile robot 112. In an embodiment, the data about the user boundaries may include data about a plurality of radial distances. In operation 315, the user device 122 and the mobile robot 112 may perform positioning on each other by exchanging positioning information with each other. The user device 122 may calculate a location of the mobile robot 112 by performing positioning on the mobile robot 112 and identify a region in advance where the mobile robot 112 is located based on the data about the user boundaries. For example, the mobile robot 112 may be identified as belonging to one of the region 1 and the region 2. The mobile robot 112 may identify the location of the user device 122 by performing positioning on the user device 122. For positioning, the user device 122 and the mobile robot 112 may calculate a distance to the mobile robot 112 and a distance to the user device 122, respectively, according to the method shown in FIG. 2A. For positioning, the user device 122 and the mobile robot 112 may calculate a relative direction where the mobile robot 112 is located and a relative direction where the user device 122 is located, respectively, according to the method shown in FIG. 2B. In operation 320, the user device 122 may transmit data about the region where the mobile robot 112 is located to the mobile robot 112.

In operation 325, a value for at least one positioning variable may be determined based on the region where the mobile robot 112 is located. In an embodiment, at least one positioning variable may include a wireless signal bandwidth, information transmission period, and transmission power. With respect to the mobile robot 112 located in a region relatively close to the user device 122, the wireless signal bandwidth may be widened and the information transmission period may be shortened for more precise positioning, but the transmission power may be relatively lowered to reduce interference with the other mobile robot 114 and/or other user devices. On the other hand, for the mobile robot 112 located in a region relatively far from the user device 122, a relatively narrow bandwidth and a long transmission period may be applied for rough positioning, but the transmission power may be increased so that the wireless signal reaches a long distance. In operation 330, the user device 122 may transmit data about the determined value of the positioning variable to the mobile robot 112.

In operation 335, whether a user service request is input to the user device 122 may be tested. In an embodiment, the user service request may be input through a user input interface provided by the user device 122. For example, when a region where the mobile robot 112 is currently located is the region 1, the user service request may be a request to control the movement of the mobile robot 112 to the region 2, which is a target region. In another example, when a region where the mobile robot 112 is currently located is the region 2, the user service request may be a request to control the movement of the mobile robot 112 to the region 1, which is the target region. When it is determined that the user service request is not input as a result of the test in operation 335, the process may return to operation 335. In addition, when it is determined that the user service request is input as the result of the test in operation 335, the process may proceed to operation 340 and the user device 122 may transmit a movement control request to the mobile robot 112. As described above, the movement control request may be a request to control the movement of the mobile robot 112 to the region 1, a request to control the movement of the mobile robot 112 to the region 2, and the like. In operation 345, the mobile robot 112 may perform controlling the movement on the mobile robot 112 in response to the movement control request received in operation 340, based on the data about the user boundaries received in operation 310, the location of the user device 122 identified in operation 315, and/or the data about the region where the mobile robot 112 is located received in operation 320.

In operation 350, the user device 122 may identify the region where the mobile robot 112 is located by performing positioning on the mobile robot 112, by exchanging the positioning information with the mobile robot 112 by applying the value of at least one positioning variable determined in operation 325. In operation 350, the positioning on the mobile robot 112 may be performed in a manner similar to that in operation 315. In operation 355, whether a region where the mobile robot 112 is currently located is the same as the target region may be tested. When it is determined that the region where the mobile robot 112 is currently located is not the same as the target region as a result of the test in operation 355, the process may return to operation 350. In addition, when it is determined that the region where the mobile robot 112 is currently located is the same as the target region as the result of the test in operation 355, the process may proceed to operation 360 and the user device 122 may send a confirmation signal to the mobile robot 112. In operation 365, whether a user boundary renewal request is input to the user device 122 may be tested. In an embodiment, the user boundary renewal request may be input through an input interface provided by the user device 122. When it is determined that the user boundary renewal request is not input as a result of the test in operation 365, the process may return to operation 315. In addition, when it is determined that the user boundary renewal request is input as the result of the test in operation 365, the process may return to operation 305. Furthermore, in operation 370, the mobile robot 112 may test whether the confirmation signal is received. When it is determined that the confirmation signal is not received as a result of the test in operation 370, the process may return to operation 345 and repeat controlling the movement of the mobile robot 112. In addition, when it is determined that the confirmation signal is received as the result of the test in operation 370, the process in the mobile robot 112 may be terminated.

The examples described herein may be implemented using hardware components, software components and/or combinations thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method performed by a user device to control a movement of a mobile robot between user regions, the method comprising:
setting user boundaries, wherein a plurality of regions based on the user device is defined by the user boundaries;
transmitting data about the set user boundaries to the mobile robot;
transmitting a movement control request to the mobile robot in response to an input of a user service request, wherein the movement control request is a request to perform a movement control to move the mobile robot to a target region, and the target region is one of the plurality of regions;
identifying a region where the mobile robot is located by performing positioning on the mobile robot; and
allowing the movement control of the mobile robot to be stopped by transmitting a confirmation signal to the mobile robot when the identified region where the mobile robot is located is the same as the target region.

2. The method of claim 1, further comprising, prior to the transmitting of the movement control request to the mobile robot in response to the input of the user service request:
previously identifying a region where the mobile robot is located by performing positioning on the mobile robot, wherein the region where the mobile robot is located is one of the plurality of regions,
wherein the target region is different from the previously identified region where the mobile robot is located.

3. The method of claim 2, further comprising, prior to the transmitting of the movement control request to the mobile robot in response to the input of the user service request:
determining a value of at least one positioning variable based on the previously identified region where the mobile robot is located.

4. The method of claim 3, wherein the identifying of the region where the mobile robot is located by performing the positioning on the mobile robot comprises applying the determined value of the at least one positioning variable and identifying the region where the mobile robot is located, by performing the positioning on the mobile robot.

5. The method of claim 3, wherein the at least one positioning variable comprises at least one of a wireless signal bandwidth, an information transmission period, and transmission power.

6. The method of claim 5, wherein the determining of the value of the at least one positioning variable based on the previously identified region where the mobile robot is located comprises determining the wireless signal bandwidth to be relatively wide, determining the information transmission period to be relatively short, and determining the transmission power to be relatively low, when the identified region in advance where the mobile robot is located is a region relatively close to the user device.

7. The method of claim 5, wherein the determining of the value for at least one positioning variable based on the identified region in advance where the mobile robot is located comprises determining the wireless signal bandwidth to be relatively narrow, determining the information transmission period to be relatively long, and determining the transmission power to be relatively high, when the identified region in advance where the mobile robot is located is a region relatively far from the user device.

8. The method of claim 2, further comprising, after the identifying of the region in advance where the mobile robot is located by performing the positioning:
transmitting data about the identified region in advance where the mobile robot is located to the mobile robot.

9. The method of claim 3, further comprising, after the determining of the value for at least one positioning variable based on the identified region in advance where the mobile robot is located:
transmitting data about the determined value of at least one positioning variable to the mobile robot.

10. A method performed by a mobile robot to control a movement of a mobile robot between user regions, the method comprising:
receiving data about user boundaries from a user device, wherein a plurality of regions based on the user device is defined by the user boundaries;
identifying a location of the user device;
receiving data about a region where the mobile robot is located from the user device;
performing a movement control on the mobile robot, based on the data about the user boundaries, the identified location of the user device, and the data about the region where the mobile robot is located, in response to receiving a movement control request from the user device; and
stopping the movement control on the mobile robot in response to receiving a confirmation signal from the user device.

11. The method of claim 10, wherein the movement control request is a request to perform the movement control to move the mobile robot to a target region, wherein the target region is one of the plurality of regions and a region different from the region where the mobile robot is located.

12. A non-transitory computer-readable storage medium storing instructions that, when executed by a processor, cause the processor to perform the method of claim 1.
